(19) United States
(12) Patent Application Publication
(10) Pub. No.: US 2003/0053936 A1
(43) Pub. Date: Mar. 20, 2003

(54) Opto-acoustic wave chemical sensor

(75) Inventors: Radislav Alexandrovich Potyrailo, Niskayuna, NY (US); Timothy Mark Sivavec, Clifton Park, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 09/920,281

(22) Filed: Aug. 2, 2001

(51) Int. Cl. G01N 21/01

(52) U.S. Cl. 422/82.11; 436/164; 436/169; 422/82.01; 422/82.05; 422/82.09; 422/55; 422/56; 250/227.21; 250/577

(57) ABSTRACT

An opto-acoustic wave sensor provides for the detection, the determination of the location, and/or the quantification of an amount of a chemical species using a selective chemical interaction of the chemical species and a selective reagent disposed on a surface of the opto-acoustic wave sensing element. The amount of the chemical species is detected by a change in the mass of the opto-acoustic wave-sensing element, which results in a detectable change in a resonance frequency of the sensing element. The identity of the chemical species is ascertained by an optical property of the product of the selective chemical interaction such as an absorbance or an intensity or other properties of the electromagnetic radiation emitted by the product. The sensor may be used in a method for detecting, determining the location or the spatial distribution of, and quantifying a wide range of chemical compounds, such as for monitoring chemicals in environment and industrial facilities and determining products in a combinatorial experiment.

### CROSS REFERENCE TO RELATED APPLICATION

This application is related to patent application Ser. No. ______; titled “Apparatus And Method for Spatially Detecting or Quantifying Chemical Species Using Selective Chemical Interaction,” filed on ______; and pending patent application Ser. No. 09/441,851; titled “Poly(glycinamide) Composition, Method for Production of a Poly(glycinamide) Composition, TCE-Detecting Method And Sensor,” filed on Nov. 17, 1999.

### BACKGROUND OF THE INVENTION

The present invention relates to an apparatus and a method for detecting, ascertaining the location of, or quantifying chemical species. In particular, the present invention relates to an apparatus and a method for remotely detecting or quantifying chemical species using a selective chemical interaction and an opto-acoustic wave detection of products of such chemical interaction.

As used herein, the term “opto-acoustic wave detection” refers to a method of detection wherein the identity and the amount or concentration of a chemical species is ascertained by a combination of at least one optical signal and one acoustic wave signal.

As industrial and commercial activities continue to accelerate, many man-made chemical species have found their way into the environment, heightening concern about human health and safety. Halogenated hydrocarbons that have been used as industrial solvents, medium for extraction of natural products, degreasing agents, dry cleaning fluids, refrigerants, fuel additives, fumigants, and intermediates for the synthesis of a multitude of other organic compounds have appeared in ground water at numerous locations. Other chemical compounds, such as explosives and rocket propellants, have contaminated soil at and migrated beyond manufacturing sites. Concern about the health effects of chemical compounds such as these in the environment has led to the quest for better methods for detecting and monitoring their presence. Many colorless or optically transparent chemical species react with selected reagents to yield colored or fluorescent products, which can provide the basis for the detection of such chemical species.

One such method of detection is based on the reaction of halogenated hydrocarbons with pyridine or pyridine derivatives in an alkaline medium to yield red colored products in what has been commonly known as the Fujiwara reaction.

Many other compounds react with selected reagents to yield products that absorb electromagnetic (“EM”) radiation in the wavelength range from ultraviolet (“UV”) to infrared (“IR”). For example, some polynitroaromatic compounds react with ethylenediamine to yield products that absorb at wavelength of about 455 nm or about 530-560 nm.

The optical effects of selective chemical interaction have been incorporated in optical fibers for the determination of the location or the spatial distribution of selected chemical compounds by measuring the backpropagated EM radiation. Such method is known as “optical time-domain reflectometry” or “OTDR.” For example, a fiber-optic waveguide having an aluminosilica xerogel clad was used to detect the spatial distribution of quinizarin (1,4-dihydroxyanthraquinone) (C. A. Browne et al., “Intrinsic Sol-Gel Clad Fiber-Optic Sensors With Time-Resolved Detection,” Anal. Chem., Vol. 68, No. 14, 2289 (1996)). Quinizarin adjacent to the optical fiber sensor complexes with aluminum in the clad to yield a product that strongly absorbs EM radiation at wavelength of about 560 nm. Therefore, a measurement of the light intensity at wavelength of 560 nm and the arrival time at the detector of the return light of a pulse of light launched into the fiber-optic waveguide indicates the concentration and the location of quinizarin.

However, the basic OTDR method has several disadvantages that limit its appeal in quantitative chemical detection. The most important disadvantage is the low intensity of detected backpropagated radiation which can be 10²-10⁵ times weaker than the forward traveling pulse. As a result, recording a useful signal of backpropagated radiation for an accurate quantitation of the chemical species requires sophisticated detection schemes, high-power lasers, and time-consuming signal-averaging techniques. Frequently, signal integration times are in the range of several tens of minutes and involve averaging 10⁵-10⁷ waveforms. Several methods have been devised and demonstrated to raise the levels of these signals. These methods include those based on pseudonoise, polarimetry, and non-linear optical effects. Unfortunately, these techniques are limited to the use of single-mode optical fibers, which are very difficult to implement for chemical detection. Therefore, it is a challenge to use such optical methods to determine an amount of a chemical compound at trace levels.

On the other hand, sensors having an acoustic wave-sensing element, such as quartz crystal microbalance (“QCM,” an acoustic wave thickness-shear-mode (“TSM”) device) and surface-acoustic-wave (“SAW”) sensor, can readily detect amounts of a chemical species when the presence of such chemical species can increase the mass of the acoustic wave-sensing element. A thin coating may be deposited on the acoustic wave-sensing element to promote an adsorption or absorption of a chemical species, thereby increasing the mass of the sensing element and producing a change in the resonance frequency of the acoustic wave-sensing element that is related to the amount and identity of the chemical species. Coatings have been made with polymeric materials that have high capacity for absorption of but little ability to differentiate the chemical species.

Therefore, there is a continued need for simple apparatuses and convenient methods for detecting, identifying, determining the location of, and quantifying chemical species. It is also desirable to have such simple apparatuses and methods for readily implementing in the field.

### SUMMARY OF THE INVENTION

The present invention provides an apparatus and a method for detecting the presence, identifying, and quantifying an amount of at least one chemical species using selective interaction between the chemical species and selected reagents on an opto-acoustic wave sensing element. As used herein, the term “chemical interaction” refers to a coupling via a formation of permanent or temporary bonds between the chemical species and a selected reagent to yield a product species. The term “chemical interaction” includes, but is not limited to, chemical reaction, formation of chemical complexes, hydrogen bonding, and hydration. The apparatus and method of the present invention can also provide information about the location of the chemical species. As used herein, the term “opto-acoustic wave” means being capable of generating a detectable acoustic wave and providing a measurable optical signal.

An apparatus of the present invention comprises (1) an opto-acoustic wave sensing element that comprises an acoustic wave element, at least two electrodes, and a coating being disposed on at least one portion of the acoustic wave element and comprising at least one reagent that is capable of undergoing a selective chemical interaction with the chemical species to be detected to yield at least one optically detectable interaction product; (2) a source of electromagnetic (“EM”) radiation optically coupled to the opto-acoustic wave sensing element, the EM radiation source providing EM radiation having a wavelength that is matched to an optical property of the product of the selective chemical interaction; (3) a first detector for detecting a change in a property of the opto-acoustic wave sensing element selected from the group consisting of mass, viscoelastic, and dielectric properties; and (4) a second detector for detecting the optical property of the interaction product.

According to one aspect of the present invention, the first detector is capable of relating a change in the resonant frequency or other acoustic-wave characteristic parameters of the acoustic wave sensing element to a change in the mass, viscoelastic, or dielectric property thereof, and therefore, an amount and an identity of the chemical species at the location of the sensing element; the optical property of the interaction product gives rise to an optical signal; and the second detector is capable of relating the optical signal to the amount and identity of the chemical species. Such other acoustic-wave characteristic parameters are, for example, fundamental oscillation frequency, harmonic oscillation frequency, impedance phase and magnitude (for one-port devices, such as a TSM device) impedance phase and attenuation (for two-port devices, for example, a SAW device), wave velocity, wave attenuation, capacitance, and conductance.

In another aspect of the present invention, the optical signal is an absorbance or an intensity of an emission of EM radiation having wavelength in the range of UV to IR (or from about 100 nm to about 1 mm).

In still another aspect of the present invention, the apparatus further comprises an optical waveguide optically coupled to the opto-acoustic wave-sensing element. The waveguide receives EM radiation from the EM radiation source.

A method of the present invention for detecting the presence, identifying, determining the location, and quantifying an amount of at least one chemical species comprises: (1) providing: (a) an opto-acoustic wave sensing element that comprises an acoustic wave element, at least two electrodes, and a coating being disposed on at least one portion of the acoustic wave element and comprising at least one reagent that is capable of undergoing a selective chemical interaction with the chemical species to be detected to yield at least one optically detectable interaction product; (b) a source of EM radiation optically coupled to the opto-acoustic wave sensing element, the EM radiation source providing EM radiation having a selected wavelength that is matched to an optical property of the product of the selective chemical interaction; (c) a first detector for detecting a change in a mass of the acoustic wave sensing element; (d) a second detector for detecting the optical property of the interaction product; (2) allowing the chemical species to selectively interact with the at least one reagent to yield the at least one optically detectable product and to change a property of the acoustic wave sensing element, which property is selected from the group consisting of mass, viscoelastic, and dielectric property of the sensing element; (3) launching into the opto-acoustic wave sensing element at least an input pulse of EM radiation at the selected wavelength, the input pulse having a radiation optical property; (4) collecting an output pulse of the EM radiation having a changed radiation optical property; (5) relating the change in the radiation optical property to an identity and an amount of the chemical species; and (6) relating the change in mass of the acoustic wave sensing element to an identity and an amount of the chemical species at the location of the acoustic wave sensing element.

According to one aspect of the present invention, a plurality of opto-acoustic wave sensing elements is provided in the apparatus of the present invention. Each of the opto-acoustic wave sensing elements has a coating on a portion thereof that comprises a reagent that is capable of undergoing a selective chemical interaction with one of a number of chemical species suspected to be present at the location.

Other features and advantages of the present invention will be apparent from a perusal of the following detailed description of the invention and the accompanying drawings in which the same numerals refer to like elements.

### BRIEF DESCRIPTION OF THE DRAWINGS

FIG. 1 is a schematic diagram of a first embodiment of an apparatus of the present invention in which EM radiation is detected after an internal reflection within the opto-acoustic wave-sensing element.

FIG. 2 is a schematic diagram of a second embodiment of an apparatus of the present invention in which EM radiation is detected after a transmission through the opto-acoustic wave-sensing element.

FIG. 3 is a schematic diagram of a third embodiment of an apparatus of the present invention in which a waveguide is coupled to the opto-acoustic wave sensing element for transmitting EM radiation thereto and receiving EM radiation therefrom.

### DETAILED DESCRIPTION OF THE INVENTION

An apparatus and the method of the present invention are advantageously employed in detecting the presence of a wide range of chemical species, determining their locations, and quantifying their amounts at these locations.

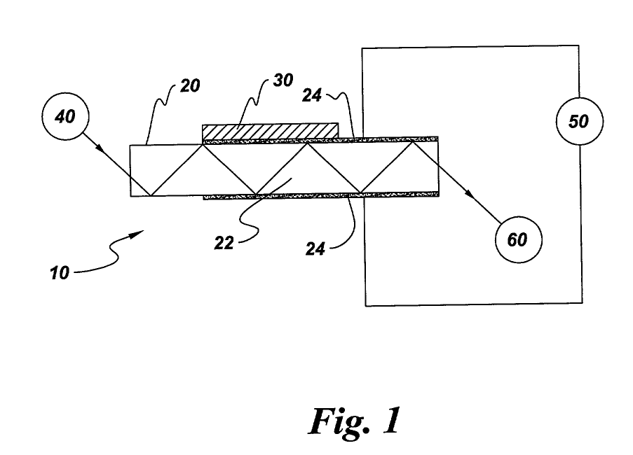

FIG. 1 shows schematically a first embodiment of an apparatus of the present invention. The apparatus 10 comprises (1) an opto-acoustic wave sensing element 20 that comprises an acoustic wave element 22, two electrodes 24, and a coating 30 on at least one portion of the acoustic wave element 22 and comprising at least one reagent that is capable of undergoing a selective chemical interaction with a chemical species to be detected to yield at least one optically detectable interaction product, which chemical species is in the vicinity of the opto-acoustic wave sensing element 20; (2) a source 40 of electromagnetic (“EM”) radiation optically coupled to the opto-acoustic wave sensing element 20, the EM radiation source providing EM radiation having a wavelength that is matched to an optical property of the product of the selective chemical interaction; (3) a first detector 50 for detecting a change in a mass of the acoustic wave sensing element 20; and (4) a second detector 60 for detecting the optical property of the interaction product. The coating 30 with the selective reagent for the chemical species imparts to the acoustic wave-sensing element the additional optical characteristic and, thus, the ability to accurately identify the chemical species. The acoustic wave-sensing element 22 may be a thickness-shear-mode (“TSM”) device, such as a QCM; a SAW sensor; a flexural-acoustic-plate-wave (“FPW”) sensor; or a shear-horizontal-acoustic-plate-mode (“SH-APM”) sensor. FIG. 1 depicts a QCM wherein the coating is deposited on an electrode for maximum sensitivity. Alternatively, when the acoustic wave element is of the SAW, FPW, or SH-APM type, two sets of electrodes are provided on the same surface of the sensing element and the coating is formed in the region between these two sets of electrodes.

A simplified relation between the changes in the fundamental resonant frequency and the mass of the acoustic wave-sensing element is given in Equation 1.

Δf/f₀=−SₘΔm (Equation 1)

where Δf and Δm are the changes in the fundamental resonant frequency and the mass of the acoustic wave-sensing element, respectively; f₀ is the fundamental resonant frequency, and Sₘ is proportionality constant with units of square centimeters per gram. Sₘ depends on the nature of the acoustic wave substrate, device dimension, frequency of operation, and the acoustic mode that is utilized. Typical values for the types of acoustic wave devices mentioned above are shown in Table 1 (see, M. D. Ward and D. A. Buttry, “In Situ Interfacial Mass Detection With Piezoelectric Transducers,” Science, Vol. 249, 1000 (August 1983).

TABLE 1

| Device | Typical f₀ (MHz) | Typical Sₘ (cm²g⁻¹) |
|---|---|---|
| QCM | 6 | 14 |
| SAW | 112 | 151 |
| FPW | 2.6 | 951 |
| SH-APM | 104 | 65 |

Mass change Δm is due to selective absorption and chemical interaction between the chemical species to be detected and the reagent contained in coating 30. Therefore, a careful selection of the coating material and the reagent that selectively interacts with a chemical species suspected to be present provides a way to identify the chemical species. Many reagents selectively interact with selected chemical species to yield products that absorb or emit EM radiation at characteristic wavelengths in the range from UV to IR (or from about 100 nm to about 1 mm).

The opto-acoustic wave element 20 may comprise one of a number of acoustic wave materials, such as quartz, gallium arsenite, lithium niobate, zinc oxide, or alkali and alkali earth fluoride. A preferred acoustic wave element is a thin piece of quartz crystal that is cut at a specified angle with respect to the z-axis of the crystal. For example, the so-called AT-cut (35⁰15′ rotation with respect to z-axis) and BT-cut (−49⁰ with respect to z-axis) quartz crystals are little affected by temperature change and, therefore, are very suitable for sensor manufacture. Electrodes are typically pattern-deposited on surfaces of the acoustic wave element. When the device is a QCM, the electrodes are deposited on opposite surfaces of the acoustic wave crystal element and the coating containing the reagent is typically deposited on at least one of the electrodes. In order for the optical property of the interaction product in the coating to affect the optical property of the input light beam, the electrode under the coating is preferably transparent. A suitable material for such an electrode is indium tin oxide (“ITO”) and is built to a thickness from about 50 nm to about 400 nm, preferably from about 50 nm to about 200 nm. In the present invention, the light beam may be provided as a continuous beam or in pulses.

For example, in FIG. 1, a focused input light beam having a characteristic wavelength of the interaction product is launched into the opto-acoustic wave element 20. The source for the light beam may be a lamp (such as xenon arc lamp, mercury arc lamp, deuterium lamp, tungsten lamp), a light-emitting diode (“LED”), various kinds of lasers, or a laser diode. The light beam interacts with the coating, and a portion of its intensity is absorbed or another of its property is modified by the product of the chemical interaction in the coating. Alternatively, the product of the chemical interaction may emit light that is detectable. The remainder of the input light beam exits the opto-acoustic wave element, and its intensity or another light property is measured. The absorption of light at the characteristic wavelength of the light beam or another measurable light property (such as luminescence or scattering) is due to the presence of the interaction product in the coating and is related to the identity of the chemical species.

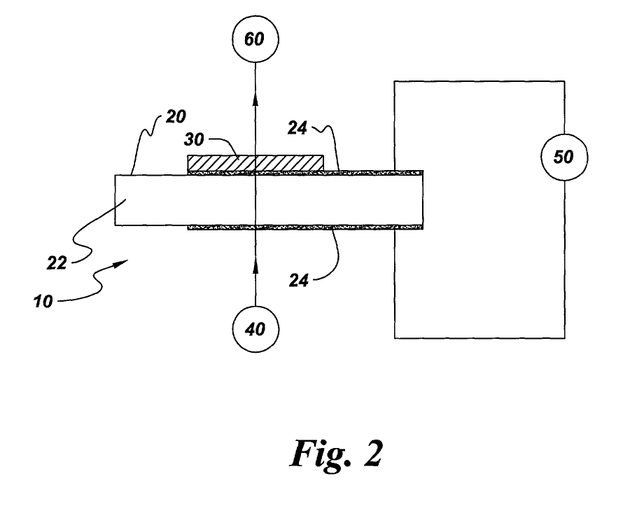

In an alternative second embodiment as shown in FIG. 2, a continuous or pulsed light beam at the characteristic wavelength traverses the first electrode, the acoustic wave element, the second electrode, and the coating. A portion of the intensity or other measurable light property of the light beam is modified by the interaction product and provides information on the identity and amount of the chemical species. In the first and second embodiments, the acoustic wave element also functions as a waveguide and its material is selected for minimum intrinsic optical loss.

In a third embodiment of the present invention, the acoustic wave element and the waveguide, each having a coating deposited thereon, are separate but are located in proximity to each other for the detection of a chemical species at that location. The materials of the acoustic wave element and the waveguide are thus selectable for their respective optimal performance. For example, the material for acoustic wave element may be chosen for its maximum response to a change in mass, viscoelastic or dielectric property of the coating while that for the waveguide for its minimum optical loss. Similarly, the material of a coating may be chosen so to have optimal performance for its function. For example, the material of the coating on the acoustic wave element may be chosen to have a maximum absorption capacity for the chemical species while that of the coating on the waveguide for its compatibility with or its capacity to hold large amounts of the reagent. In this embodiment, the coating on the respective sensing element (i.e., the acoustic wave or the optical element) may be deposited at location that produces maximum sensitivity. For example, when the acoustic wave element is a QCM, the coating is preferably deposited on an electrode at the center of the quartz crystal element while the coating on the waveguide may cover a significant portion of the surface of the waveguide. In addition, in this embodiment the acoustic wave and the optical elements may advantageously have different geometries. For example, the acoustic wave element may be a thin circular wafer (as in the QCM) or a rectangular piece (as in the SAW sensor) while the waveguide may be a cylindrical optical fiber.

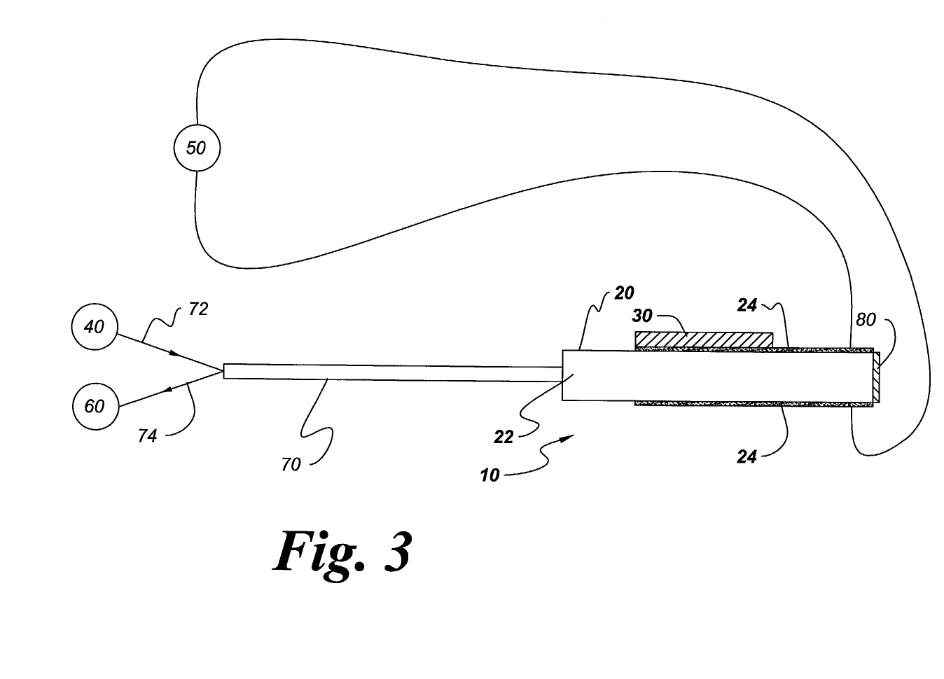

In a fourth embodiment of the present invention as shown schematically in FIG. 3, at least one waveguide 70 is optically coupled to the opto-acoustic wave-sensing element. Waveguide 70 may be an optical fiber or a bundle of optical fibers. A forward-traveling light beam 72 at the characteristic wavelength is launched into this waveguide, traveling to the opto-acoustic wave-sensing element 20, which is located remotely from light source 40 and detectors 50 and 60. A portion of the intensity of light beam 72 is absorbed by the product of the chemical interaction in coating 30. The returning light beam 74 is detected and its intensity is measured by detector 60. The absorption of light at the characteristic wavelength provides an identification of the chemical species. The amount of light absorption further provides an independent quantitation of the chemical species beside that provided by the change in the resonant frequency of the opto-acoustic wave-sensing element 20. A reflector 80 may be disposed on opto-acoustic wave element 20 opposite to waveguide 70 to ensure that light is reflected back to waveguide 70 for detection by detector 60. In addition, a lens (not shown) may be interposed between opto-acoustic wave element 20 and waveguide 70 to focus the returning light into waveguide 70.

The reagent for a particular chemical species to be detected is preferably selected to yield a product that strongly absorb EM radiation, such as UV, visible, or IR EM radiation. Alternatively, the product may emit detectable EM, especially in the visible spectrum. Preferably, the reagent is chosen such that the product of the reaction or interaction provides an optical signature substantially unique to the chemical species to be detected. An optical signature may be represented by a measurable optical signal. More than one optical signal, such as absorbances at two different wavelengths or other light properties, may be measured to uniquely identify the chemical species.

The coating 30 may be made of any suitable polymeric material that is permeable to the specific chemical species to be detected but resistant to damage by environmental conditions. Suitable polymeric materials for producing a coating of the present invention are polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof. The coating 30 may be mesoporous (having pore size in the range from about 1 nm to about 100 nm) or microporous (having pore size in the range from about 100 nm to about 1000 nm). The pore size is selected so to obtain a reasonably rapid diffusion or permeation rate of the chemical species into and throughout the coating. The larger the molecular size of the chemical species, the larger the pore size should be. The pore size is preferably in the range from about 1 nm to about 200 nm, more preferably from about 1 nm to about 100 nm, and most preferably from about 1 nm to about 50 nm. The thickness of the coating is typically in the range from about 10 nm to about 100 micrometers, preferably from about 20 nm to about 50 micrometers, more preferably from about 50 nm to about 10 micrometers. The polymeric material may be deposited on the acoustic wave-sensing element by spraying, dipping, painting, or by depositing a monomer from the vapor phase and then polymerizing the monomer. The formation of the coating is advantageously carried out by a pattern deposition using a mask similar to microelectronic manufacture. Alternatively, the porous polymeric material may be impregnated in another porous support such as a thin film of porous glass; quartz; or piezoelectric material, non-limiting examples of which are gallium arsenite, lithium niobate, or zinc oxide; which is in turn deposited on the acoustic wave element.

At least one reagent for selectively interacting with the chemical species is incorporated in the coating. The reagent may be chemically attached to the coating material such that a functional group responsible for the selective interaction with the chemical species is free to undergo this interaction. Such a functional group may be a moiety on the reagent or a part of the reagent molecule that offers a unique steric configuration for accepting a complementarily shape chemical species. An example of the latter interaction is that between an enzyme and a substrate. A reagent may even be a cell or part of a cell so that its membrane may be used to recognize biochemical species. A reagent also can be a single stranded nucleic acid, known as an aptamer, folded into a specific conformation and sensitive to a variety of targets that are, for example, metal ions, proteins, living cells, viruses, tissues, etc. Alternatively, the reagent may be retained in the pores of the coating material by surface tension. The reagent may be advantageously mixed with a suitable solvent or matrix having a low vapor pressure before impregnating into the pores of the coating to inhibit the escape of the reagent and to increase the shelf life of the sensing element. Depending on the nature of the chemical species suspected to be present, the solvent or matrix may be chosen to promote or enhance the solubilization of the chemical species therein. For example, a hydrophobic solvent or matrix may be advantageously used for hydrophobic chemical species, and hydrophilic solvent or matrix for hydrophilic chemical species.

According to one aspect of the present invention, an opto-acoustic wave chemical sensor of the present invention is used to detect, or to determine the location of a chemical species in soil, or to quantify the amount of the chemical species at various depths in the soil. A small well is drilled into the ground to a desired depth where the chemical species is suspected to be present. An opto-acoustic wave chemical sensor having a coating containing a reagent that can interact with the chemical species suspected to be present is dropped into the well. Sufficient time is allowed for the reagent to react or interact with the chemical species to yield the optically sensitive and detectable product. A pulsed or continuous beam of light at the characteristic absorption wavelength of the product of chemical interaction is launched into a waveguide leading to the opto-acoustic wave-sensing element to detect the absorbance of the product. If the chemical species is present, its interaction with the reagent in the coating increases the mass of the opto-acoustic wave-sensing element, providing a change in the resonance frequency and a determination of the amount of the chemical species in the well. The returning light beam having a modified optical property at the characteristic probe wavelength, traveling through the same or a different waveguide, is detected above the well. The modulation of optical signal of the characteristic wavelength provides a confirmation of the presence of and a positive identification of the chemical species in the well. The magnitude of the modulation of the optical signal further provides an independent quantitation of the amount of chemical species. More than one opto-acoustic wave sensing element or sensor, each having a different coating and reagent, may be dropped into the same well for the detection of different chemical species that are likely to be in the well. In such a case, it may be desirable to launch a beam of light at a different characteristic wavelength set for each specific possible product of chemical interaction into a separate waveguide associated with each opto-acoustic wave sensing element.

Other uses of the sensor of the present invention are also envisioned. For example, the presence and quantity of a chemical species in an area may be determined by laying the opto-acoustic wave sensing element on the area and determining the magnitude of the changes in the resonant frequency and the absorbance at the characteristic wavelength. For example, several sensors of the present invention may be bundled together, each of which may be used to detected and quantify a chemical species in an array of cells used for chemical synthesis in a combinatorial chemistry experiment.

The following examples show compounds that may be detected and quantified by an apparatus comprising an opto-acoustic wave-sensing element and by a method of the present invention.

Determination of Trichloroethylene (“TCE”)

The Applicants have discovered that TCE reacts with polyethylenimine to yield polyglycinamide in the presence of a strong base, such as sodium hydroxide according to Equation 2. Polyglycinamide can be quantitatively determined by an absorbance of IR EM radiation at 6.03 micrometers (wave number of 1658 cm⁻¹).

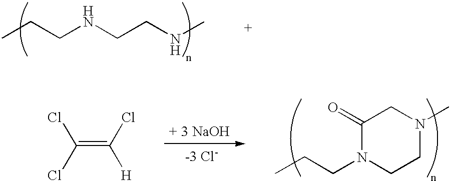

(Equation 2)

Similarly, N,N′-dialkylethylenediamine also reacts with TCE to yield N,N′-dialkylglycinamide in the presence of a strong base, such as sodium hydroxide according to Equation 3.

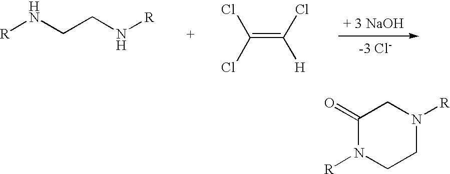

(Equation 3)

Therefore, the reaction according to Equation 2 or 3 can provide the basis for detecting TCE by measuring the IR absorbance of the content of the capillary after the reaction at wavelength of 6.03 micrometers. FIG. 2 shows the correlation between the IR absorbance of a sample containing polyglycinamide at wavelength of 6.03 micrometers and the concentration of polyglycinamide in the same sample, which can be stoichiometrically related to the concentration of TCE that reacted.

Determination of Halogenated Hydrocarbons Using an Alternate Reagent

Halogenated hydrocarbons, such as TCE, trichloroethane (“TCA”), and trihalomethanes, are known to react with pyridine or alkyl-substituted compounds of pyridine to yield colored products in the presence of a strong base according the Fujiwara reaction (U.S. Pat. No. 5,547,877; the content of which is incorporated herein as reference). Colored reaction products of chloroform, bromodichloromethane, chlorodibromomethane, bromoform, and TCE strongly absorb at wavelength of 538-540 nm. Thus, an apparatus of the present invention can be used in conjunction with the Fujiwara reaction to provide a novel method for the determination of these and other halogenated hydrocarbons.

Determination of Pyridine and its Alkyl-Substituted Compounds

Conversely, a novel method for determination of pyridine or its alkyl-substituted compounds is provided by an apparatus of the present invention on the basis of the Fujiwara reaction using a halogenated hydrocarbon as the reagent, such as TCE, chloroform, bromoform, chlorodibromomethane, or bromodichloromethane, in the presence of a strong base such as sodium hydroxide, potassium hydroxide, or tetrabutylammonium hydroxide (“TBAH”).

Determination of Polynitroaromatic Compounds

Polynitroaromatic compounds are known to react with ethylenediamine to yield products that exhibit strong absorbance in the visible wavelengths (D. J. Glover and E. G. Kayser, “Quantitative Spectrophotometric Analysis of Polynitroaromatic Compounds by Reaction With Ethylenediamine,” Anal. Chem., Vol. 40, No. 13, 2055 (1968)). This reaction can be used in an apparatus, a sensor, or a method of the present invention to determine the spatial or quantitative distribution of these compounds in an area of interest. An apparatus of the present invention includes at least an opto-acoustic wave sensing element disclosed above and associated electronic circuitry to carry out an operation thereof. For example, Table 1 shows the wavelengths at the absorbance maxima of selected polynitroaromatic compounds, which may be used as the basis for their identification in conjunction with an apparatus or method of the present invention.

TABLE 1

| Compound | Absorbance Maxima (nm) |
|---|---|
| 1,3,5-trinitrobenzene | 455, 540 |
| 2,4,6-trinitrobiphenyl | 455, 545 |
| 2,3′,4,5′,6-pentanitrobiphenyl | 450, 555 |
| 2,2′,4,4′,6,6′-hexanitrobiphenyl | 465, 530 |
| 2,4,6-trinitrotoluene | 465, 540 |
| 2,2′,4,4′,6,6′-hexatrinitrobiphenyl | 460, 550 |
| 2,2′4,4′,6,6′-hexanitrostilbene | 460, 510 |
| 2,2′,4,4′-tetranitrobiphenyl | 355, 545 |
| 3,3′,5,5′-tetranitrobiphenyl | 450, 550 |
| 2,2′,6,6′-tetranitrobiphenyl | 350, 560 |
| 1,4,5,8-tetranitronaphthalene | 320, 620 |

Determination of Polynitrobenzene and Substituted Compounds Thereof

The apparatus, sensor, or method of the present invention may be used to determine the spatial and quantitative distribution of polynitrobenzene and selected substituted compounds thereof using the specified reagent for each chemical species to be detected to obtain a product having absorbance maxima shown in Table 2. (See, E.Sawicki, “Photometric Organic Analysis, Part 1,” pp. 577-81, John Wiley and Sons, Inc., NY (1970).)

TABLE 2

| | | Absorbance |
|---|---|---|
| | | Maximum or Maxima |
| Compound | Reagent | (nm) |
| 1,3-dinitrobenzene | Methanolic KOH | 559 |
| | and acetone | |
| 1,3,5- | dibenzylketone or | 500 |
| trinitrobenzene | 2,5-pentadione | |
| 2-ethoxy-1,3,5- | sodium hydroxide | 420, 478, 494 |
| trinitrobenzene | and methanol | |
| 2-methyl-1,3- | Strong base and | 555 |
| dinitrobenzene | acetone | |
| 2,4-dimethyl-1,3- | Strong base and | 651 |
| dinitrobenzene | acetone | |

Determination of Selected Substituted Benzene

The apparatus, sensor, or method of the present invention may be used to determine the spatial and quantitative distribution of selected substituted benzene compounds using the piperonal chloride as the reagent in the presence of a strong acid to obtain a product having absorbance maxima shown in Table 3 according to the following reaction. (See, E.Sawicki, “Photometric Organic Analysis, Part 1,” p. 483, John Wiley and Sons, Inc., NY (1970).)

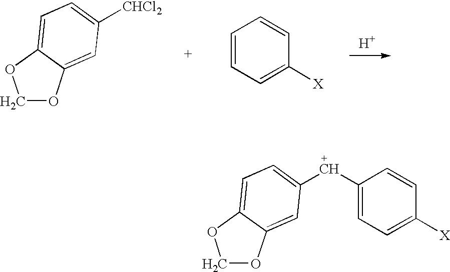

(Equation 3)

TABLE 3

| X | Absorbance Maximum (nm) |
|---|---|
| CH₃ | 513 |
| OCH₃ | 527 |
| C₆H₅ | 560 |
| SCH₃ | 575 |
| SC₆H₅ | 585 |

Determination of Selected Aromatic Aldehydes

The apparatus and method of the present invention may be used to determine the spatial and quantitative distribution of selected aromatic aldehydes using 2-nitrophenylhydrazine as the reagent in a mixture of 98% (by volume) of dimethylformamide and 2% (by volume) of a 10% (by volume) aqueous solution of tetraethylammonium hydroxide to obtain a product having absorbance maximum shown in Table 4. (See, E.Sawicki, “Photometric Organic Analysis, Part 1,” pp. 568-73, John Wiley and Sons, Inc., NY (1970).)

TABLE 4

| Compound | Absorbance Maximum (nm) |
|---|---|
| Benzaldehyde | 575 |
| 1-napthaldehyde | 600 |
| 9-anthraldehyde | 630 |
| 4-dimethylaminocinnamaldehyde | 435 |
| 2-nitrobenzaldehyde | 650 |
| 4-nitrobenzaldehyde | 665 |

Although the exemplary chemical species disclosed above are organic compounds, appropriate reagents may be used in an apparatus or a method of the present invention to identify and/or quantify inorganic compounds or inorganic/organic complexes.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An opto-acoustic wave sensor for detecting a presence, determining a location, and quantifying an amount of at least a chemical species, said opto-acoustic wave sensor comprising:
(1) an opto-acoustic wave sensing element that comprises an acoustic wave element, two electrodes coupled to said acoustic wave element, and a coating being disposed on at least one portion of said acoustic wave element and comprising at least one reagent that is capable of undergoing a selective chemical interaction with said chemical species to be detected to yield at least one optically detectable interaction product;
(2) a source of electromagnetic (“EM”) radiation optically coupled to said opto-acoustic wave sensing element, said EM radiation source providing EM radiation having a wavelength that is matched to an optical property of said product of said chemical interaction;
(3) a first detector for detecting a change in a property of said opto-acoustic wave sensing element, which property is selected from the group consisting of mass, viscoelastic, and dielectric properties; and
(4) a second detector for detecting said optical property of said interaction product.

2. The opto-acoustic wave sensor according to claim 1, wherein said acoustic wave element is selected from the group consisting of a TSM sensor, a SAW sensor, a FPW sensor, and a SH-APM sensor.

3. The opto-acoustic wave sensor according to claim 1, wherein said acoustic wave element is a TSM sensor.

4. The opto-acoustic wave sensor according to claim 3, wherein said TSM sensor is a QCM.

5. The opto-acoustic wave sensor according to claim 4, wherein said QCM comprises a quartz crystal element selected from the group consisting of an AT-cut quartz crystal element and a BT-cut quartz crystal element.

6. The opto-acoustic wave sensor according to claim 1, wherein said acoustic wave element is a SAW sensor.

7. The opto-acoustic wave sensor according to claim 4, wherein said coating is disposed on at least one electrode of said sensor.

8. The opto-acoustic wave sensor according to claim 6, wherein said coating is disposed on a surface of said sensor and between said electrodes.

9. The opto-acoustic wave sensor according to claim 1, wherein said coating comprises a porous permeable polymeric material.

10. The opto-acoustic wave sensor according to claim 9, wherein said polymeric material is selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof.

11. The opto-acoustic wave sensor according to claim 10, wherein said coating has a thickness in a range from about 10 nm to about 100 micrometers.

12. The opto-acoustic wave sensor according to claim 11, wherein said thickness is preferably in a range from about 20 nm to about 50 micrometers, and more preferably from about 20 nm to about 10 micrometers.

13. The opto-acoustic wave sensor according to claim 9, wherein said porous permeable polymeric material has pore size in a range from about 1 nm to about 200 nm.

14. The opto-acoustic wave sensor according to claim 13, wherein said pore size is preferably in a range from about 1 nm to about 100 nm, and more preferably from about 1 nm to about 50 nm.

15. The opto-acoustic wave sensor according to claim 1, wherein said coating comprises a porous solid substrate supporting a polymeric material selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof.

16. The opto-acoustic wave sensor according to claim 11, wherein said porous substrate comprises a material selected fro the group consisting of glass, quartz, and piezoelectric materials.

17. The opto-acoustic wave sensor according to claim 1, wherein said coating is porous and said reagent is chemically attached to a surface of said coating.

18. The opto-acoustic wave sensor according to claim 1, wherein said coating is porous, and a mixture of said reagent and a matrix material is deposited in said porous coating.

19. The opto-acoustic wave sensor according to claim 1, wherein said EM radiation has a wavelength is in a range from UV to IR.

20. The opto-acoustic wave sensor according to claim 19, wherein said wavelength is in a range from about 100 nm to about 1 mm.

21. The opto-acoustic wave sensor according to claim 1, wherein said optical property of said product is selected from the group consisting of absorbance and intensity of an emission of EM radiation.

22. The opto-acoustic wave sensor according to claim 1, wherein said first detector measures a change in a resonant frequency of said acoustic wave element and relates said change to a change in a mass thereof.

23. The opto-acoustic wave sensor according to claim 1, wherein said first detector measures a change in at least one parameter of the acoustic wave-sensing element, said at least one parameter being selected from the group consisting of fundamental oscillation frequency, harmonic oscillation frequency, impedance phase and amplitude, impedance phase and attenuation, wave velocity, wave attenuation, capacitance, and conductance and relates said change to a change in a mass of said acoustic wave-sensing element.

24. The opto-acoustic wave sensor according to claim 1, wherein said second detector measures a optical signal selected from the group consisting of absorbance and intensity of an emission of EM radiation.

25. The opto-acoustic wave sensor according to claim 1, wherein said chemical species is selected from the group consisting of halogenated hydrocarbons, polynitroaromatic hydrocarbons, mono-substituted benzene, aromatic aldehydes, aromatic amines, and mixtures thereof.

26. The opto-acoustic wave sensor according to claim 1, wherein said halogenated hydrocarbons are trichloroethylene, thrichloroethane, chloroform, bromoform, chlorodibromomethane, and bromodichloromethane.

27. The opto-acoustic wave sensor according to claim 25, wherein said polynitroaromatic hydrocarbons are 1,3,5-trinitrobenzene; 2,4,6-trinitrobiphenyl; 2,3′,4,5′,6-pentanitrobiphenyl; 2,2′,4,4′,6,6′-hexanitrobiphenyl; 2,4,6-trinitrotoluene; 2,2′,4,4′,6,6′-hexatrinitrobiphenyl; 2,2′,4,4′,6,6′-hexanitrostilbene; 2,24,4′-tetranitrobiphenyl; 3,3′,5,5′-tetranitrobiphenyl; 2,2′,6,6′-tetranitrobiphenyl; 1,4,5,8-tetranitronaphthalene; 1,3-dinitrobenzene; 2-ethoxy-1,3,5-trinitrobenzene; 2-methyl-1,3-dinitrobenzne; 2,4-dimethyl-1,3-dinitrobenzne; and mixtures thereof.

28. The opto-acoustic wave sensor according to claim 25, wherein said mono-substituted benzene has a formula of Ar—X, wherein Ar is a phenyl radical and X is a radical selected from the group consisting of —CH₃, —OCH₃, —C₆H₅, —SCH₃, and —SC₆H₅.

29. The opto-acoustic wave sensor according to claim 25, wherein said aromatic aldehydes are benzaldehyde, 1-naphthaldehyde, 9-anthraldehyde, 4-dimethylaminocinnamaldehyde, 2-nitrobenzaldehyde, and 4-nitrobenzaldehyde.

30. The opto-acoustic wave sensor according to claim 25, wherein said aromatic amines are pyridine and alkyl-substituted pyridines.

31. The opto-acoustic wave sensor according to claim 1 further comprising at least one optical waveguide optically coupled to said opto-acoustic wave sensing element; said optical waveguide receiving EM radiation generated by said source of EM radiation and carrying EM radiation to and from said opto-acoustic wave sensing element.

32. The opto-acoustic wave sensor according to claim 3 1, wherein said optical waveguide comprises an optical fiber.

33. The opto-acoustic wave sensor according to claim 31, wherein said optical waveguide comprises a bundle of optical fibers.

34. The opto-acoustic wave sensor according to claim 32 further comprising a lens that is interposed between said optical fiber and said opto-acoustic wave sensing element.

35. The opto-acoustic wave sensor according to claim 1, wherein said at least one reagent is selected from the group consisting of organic, inorganic, biochemical molecules, and nucleic acid.

36. An opto-acoustic wave sensor for detecting a presence, determining a location, and quantifying an amount of at least a chemical species, said opto-acoustic wave sensor comprising:
(1) an opto-acoustic wave sensing element that comprises an acoustic wave element, two electrodes coupled to said acoustic wave element, and a coating being disposed on at least one portion of said acoustic wave element and comprising at least one reagent that is capable of undergoing a selective chemical interaction with said chemical species to be detected to yield at least one optically detectable interaction product;
(2) a source of electromagnetic (“EM”) radiation optically coupled to said opto-acoustic wave sensing element, said EM radiation source providing EM radiation having a wavelength that is matched to an optical property of said product of said chemical interaction;
(3) a first detector for detecting a change in a property of said opto-acoustic wave sensing element, which property is selected from the group consisting of mass, viscoelastic, and dielectric properties; and
(4) a second detector for detecting said optical property of said interaction product;
wherein said coating comprises a porous solid substrate supporting a polymeric material selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof; said acoustic wave element is selected from the group consisting of a TSM sensor, a SAW sensor, a FPW sensor, and a SH-APM sensor; said optical property is selected from the group consisting of absorbance and intensity of emission of EM radiation; and said wavelength is in a range from about 100 nm to about 1 mm.

37. A method for detecting a presence, determining a location, and quantifying an amount of at least a chemical species, said method comprising:
(1) providing:
(a) an opto-acoustic wave sensing element that comprises an acoustic wave element, two electrodes coupled to said acoustic wave element, and a coating; said coating being disposed on at least a portion of said acoustic wave element and comprising at least one reagent that is capable of undergoing a selective chemical interaction with said chemical species to yield at least one optically detectable interaction product;
(b) a source of EM radiation optically coupled to said opto-acoustic wave element, said EM radiation having a wavelength that is matched to an optical property of said product of said selective chemical interaction;
(c) a first detector for detecting a change in a property of said opto-acoustic wave sensing element, which property is selected from the group consisting of mass, viscoelastic, and dielectric properties; and
(d) a second detector for detecting said optical property of said interaction product;
(2) allowing said chemical species to selectively interact with said at least one reagent to yield said at least one optically detectable product and to change said mass of said opto-acoustic wave element
(3) launching into said opto-acoustic wave sensing element at least an input beam of EM radiation at said selected wavelength, said input beam having a radiation optical property
(4) collecting an output beam of said EM radiation having a changed radiation optical property;
(5) relating said change in said radiation optical property to an identity and an amount of said chemical species; and
(6) relating said change in said property of said opto-acoustic wave sensing element to said identity and said amount of said chemical species at a location of said opto-acoustic wave sensing element.

38. The method according to claim 37, wherein said acoustic wave element is selected from the group consisting of a TSM sensor, a SAW sensor, a FPW sensor, and a SH-APM sensor.

39. The method according to claim 37, wherein said acoustic wave element is a TSM sensor.

40. The method according to claim 39, wherein said coating is disposed on at least one electrode of said sensor.

41. The method according to claim 39, wherein said TSM sensor is a QCM.

42. The method according to claim 41, wherein said QCM comprises a quartz crystal element selected from the group consisting of an AT-cut quartz crystal element and a BT-cut quartz crystal element.

43. The method according to claim 37, wherein said acoustic wave element is a SAW sensor.

44. The method according to claim 42, wherein said coating is disposed on a surface of said sensor and between said electrodes.

45. The method according to claim 37, wherein said coating comprises a porous permeable polymeric material.

46. The method according to claim 45, wherein said polymeric material is selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof.

47. The method according to claim 46, wherein said coating has a thickness in a range from about 10 nm to about 100 micrometers.

48. The method according to claim 47, wherein said thickness is preferably in a range from about 20 nm to about 50 micrometers, and more preferably from about 20 nm to about 10 micrometers.

49. The method according to claim 45, wherein said porous permeable polymeric material has pore size in a range from about 1 nm to about 200 nm.

50. The method according to claim 49, wherein said pore size is preferably in a range from about 1 nm to about 100 nm, and more preferably from about 1 nm to about 50 nm.

51. The method according to claim 37, wherein said coating comprises a porous solid substrate supporting a polymeric material selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof.

52. The method according to claim 51, wherein said porous substrate comprises glass.

53. The method according to claim 37, wherein said coating is porous and said reagent is chemically attached to a surface of said coating.

54. The method according to claim 37, wherein said coating is porous, and a mixture of said reagent and a matrix material is deposited in said porous coating.

55. The method according to claim 37, wherein said EM radiation has a wavelength is in a range from UV to IR.

56. The method according to claim 55, wherein said wavelength is in a range from about 1100 nm to about 1 mm.

57. The method according to claim 37, wherein said optical property of said product is selected from the group consisting of absorbance and intensity of an emission of EM radiation.

58. The method according to claim 37, wherein said first detector measures a change in a resonance frequency of said acoustic wave element and relates said change to a change in a mass thereof.

59. The method according to claim 37, wherein said second detector measures an optical signal selected from the group consisting of absorbance and intensity of an emission of EM radiation.

60. The method according to claim 37, wherein said chemical species is selected from the group consisting of halogenated hydrocarbons, polynitroaromatic hydrocarbons, mono-substituted benzene, aromatic aldehydes, aromatic amines, and mixtures thereof.

61. The method according to claim 60, wherein said halogenated hydrocarbons are trichloroethylene, thrichloroethane, chloroform, bromoform, chlorodibromomethane, and bromodichloromethane.

62. The method according to claim 60, wherein said polynitroaromatic hydrocarbons are 1,3,5-trinitrobenzene; 2,4,6-trinitrobiphenyl; 2,3′,4,5′,6-pentanitrobiphenyl; 2,2′,4,4′,6,6′-hexanitrobiphenyl; 2,4,6-trinitrotoluene; 2,2′,4,4′,6,6′-hexatrinitrobiphenyl; 2,2′,4,4′,6,6′-hexanitrostilbene; 2,2 4,4′-tetranitrobiphenyl; 3,3′,5,5′-tetranitrobiphenyl; 2,2′,6,6′-tetranitrobiphenyl; 1,4,5,8-tetranitronaphthalene; 1,3-dinitrobenzene; 2-ethoxy-1,3,5-trinitrobenzene; 2-methyl-1,3-dinitrobenzne; 2,4-dimethyl-1,3-dinitrobenzne; and mixtures thereof.

63. The method according to claim 60, wherein said mono-substituted benzene has a formula of Ar—X, wherein Ar is a phenyl radical and X is a radical selected from the group consisting of —CH₃, —OCH₃, —C₆H₅, —SCH₃, and —SC₆H₅.

64. The method according to claim 60, wherein said aromatic aldehydes are benzaldehyde, 1-naphthaldehyde, 9-anthraldehyde, 4-dimethylaminocinnamaldehyde, 2-nitrobenzaldehyde, and 4-nitrobenzaldehyde.

65. The method according to claim 60, wherein said aromatic amines are pyridine and alkyl-substituted pyridines.

66. The method according to claim 37, wherein said step of providing further comprises providing at least one optical waveguide optically coupled to said opto-acoustic wave sensing element; said optical waveguide receiving EM radiation generated by said source of EM radiation and carrying EM radiation to and from said opto-acoustic wave sensing element.

67. The method according to claim 66, wherein said optical waveguide comprises an optical fiber.

68. The method according to claim 66, wherein said optical waveguide comprises a bundle of optical fibers.

69. The method according to claim 67, wherein said step of providing further comprises providing a lens that is interposed between said optical fiber and said opto-acoustic wave sensing element.

70. The method according to claim 1, wherein said at least one reagent is selected from the group consisting of organic, inorganic, biochemical molecules, and nucleic acid.

71. A method for detecting a presence, determining a location, and quantifying an amount of at least a chemical species, said method comprising:
(1) providing:
(a) an opto-acoustic wave sensing element that comprises an acoustic wave element, two electrodes coupled to said acoustic wave element, and a coating; said coating being disposed on at least a portion of said acoustic wave element and comprising at least one reagent that is capable of undergoing a selective chemical interaction with said chemical species to yield at least one optically detectable interaction product;
(b) a source of EM radiation optically coupled to said opto-acoustic wave element, said EM radiation having a wavelength that is matched to an optical property of said product of said selective chemical interaction;
(c) a first detector for detecting a change in a property of said opto-acoustic wave sensing element, which property is selected from the group consisting of mass, viscoelastic, and dielectric properties; and
(d) a second detector for detecting said optical property of said interaction product;
(2) allowing said chemical species to selectively interact with said at least one reagent to yield said at least one optically detectable product and to change said property of said opto-acoustic wave element
(3) launching into said opto-acoustic wave sensing element at least an input beam of EM radiation at said selected wavelength, said input beam having a radiation optical property;
(4) collecting an output beam of said EM radiation having a changed radiation optical property;
(5) relating said change in said radiation optical property to an identity and an amount of said chemical species; and
(6) relating said change in said property of said opto-acoustic wave sensing element to said identity and said amount of said chemical species at a location of said opto-acoustic wave sensing element;
wherein said coating comprises a porous solid substrate supporting a polymeric material selected from the group consisting of polytetrafluoroethylene (“PTFE”), poly(vinyl chloride) (“PVC”), poly(vinyl alcohol) (“PVA”), polyurethane, polyolefins such as polyethylene or polypropylene, polycarbonate, polystyrene, polyamide, poly(vinylidene fluoride) (“PVDF”), polyarylsuphones, polyacrylonitrile, polyether, polyetherurethane, poly(ether thioether), poly(methyl methacrylate), polyvinylpyrrolidone, polysiloxane, nylon, cellulose and its derivatives, copolymers thereof, and blends thereof; said acoustic wave element is selected from the group consisting of a TSM sensor, a SAW sensor, a FPW sensor, and a SH-APM sensor; said optical property is selected from the group consisting of absorbance and intensity of emission of EM radiation; and said wavelength is in a range from about 100 nm to about 1 mm.

72. The method according to claim 37, wherein said method is used to detect a presence and to quantify products of a chemical synthesis that is conducted in a combinatorial chemistry experiment.

73. The method according to claim 37, wherein said method is used to detect a presence and to quantify products of a chemical analysis that is conducted in a combinatorial chemistry experiment.
